(19) United States
(12) Patent Application Publication
(10) Pub. No.: US 2009/0003169 A1
(43) Pub. Date: Jan. 1, 2009

(54) OPTICAL DISC APPARATUS, OPTICAL DISC APPARATUS CONTROLLER AND DEFECT DETECTION METHOD

(75) Inventors: Norikatsu Chiba, Kawasaki-shi (JP); Yukiyasu Tatsuzawa, Yokohama-shi (JP); Toshihiko Kaneshige, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/141,710

(22) Filed: Jun. 18, 2008

(30) Foreign Application Priority Data
Jun. 29, 2007 (JP) 2007-173489

(51) Int. Cl. G11B 5/58

(52) U.S. Cl. 369/53.17

(57) ABSTRACT

According to one embodiment, An optical disc apparatus includes a decoder including branchmetric calculation section configured to calculate a branchmetric for the signal generated by executing a predetermined process on read signal obtained from a optical disc, pathmetric selection section configured to select a maximum likelihood pathmetric according to the branchmetric calculated by the branchmetric calculation section and a path memory having memory stages, each consisting of memory elements, configured to obtain a decoded signal by shifting the information to be stored in the memory to a memory of a subsequent stage according to the outcome of selection of the pathmetric selection section, and defect detection section configured to detect a defect of the optical disc according to the information possessed by the memory of the last stage or of a specific stage of the path memory.

### CROSS-REFERENCE TO RELATED APPLICATIONS

This application is based upon and claims the benefit of priority from Japanese Patent Application No. 2007-173489, filed Jun. 29, 2007, the entire contents of which are incorporated herein by reference.

### BACKGROUND

1. Field

One embodiment of the invention relates to an optical disc apparatus, an optical disc apparatus controller and a defect detection method for detecting any defect of an optical disc.

2. Description of the Related Art

Unlike hard disc apparatus, optical disc apparatus reproduce signals from removable disc s and hence it is desirable that an optical disc apparatus can reliably reproduce signals from an optical disc if the optical disc has a defect such as a scar and/or carries a stain such as dirt or a fingerprint. When an optical disc has a defect, not only the signal recorded on the optical disc is disturbed by it and can no longer be reproduced properly but also its adverse effect remains for some time on some of the circuits of the optical disc apparatus such as the adaptive equalizing filter provided to adaptively and properly operate, using the input signal, so that the signal may not be reproduced reliably immediately after getting rid of the defect. The net result can be that the apparatus keeps on sending out abnormal data for a certain time period after the signal input from the optical disc restores the supply of normal data.

A technique of detecting the peak and the bottom of the signal obtained from an optical disc typically by means of a low-pass filter and recognizing the signal as defective when the peak value and the bottom value exceed respective threshold values has been disclosed (Jpn. Pat. Appln. Laid-Open Publication No. 2005-166121).

However, when an optical disc having a defect of an amplitude that fluctuates with a short period is replayed, it is difficult to detect the defect by means of the method using a low-pass filter because the envelop of the waveform generated by the low-pass filter shows only little changes.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic block diagram of an embodiment of optical disc apparatus according to the present invention;

FIG. 2 is an exemplary schematic block diagram of a maximum likelihood decoder of FIG. 1;

FIG. 3 is an exemplary schematic circuit diagram of a path memory of FIG. 2;

FIG. 4 is an exemplary schematic illustration of the contents of a last stage memory of the path memory;

FIG. 5 is an exemplary schematic circuit diagram of an exemplar defect detector that can be used for the embodiment of FIG. 1;

FIG. 6 is an exemplary schematic illustration showing an example of inside of the defect detector of FIG. 5;

FIG. 7 is an exemplary schematic illustration showing another example of inside of the defect detector of FIG. 5;

FIG. 8A, FIG. 8B, FIG. 8C, and FIG. 8D are exemplary schematic illustrations of a DVD-ROM waveform containing a defect and an output example of the defect detector; and

FIG. 9 is an exemplary flowchart of the sequence of the control process of controlling an adaptive learning circuit to be executed by the control section shown in FIG. 1.

### DETAILED DESCRIPTION

Various embodiments according to the invention will be described hereinafter with reference to the accompanying drawings. In general, according to one embodiment of the invention, an optical disc apparatus a read section configured to read reflected light from an optical disc and outputting a read signal corresponding to the reflected light, a decoder including branchmetric calculation section configured to calculate a branchmetric for the signal generated by executing a predetermined process on the read signal, pathmetric selection section configured to select a maximum likelihood pathmetric according to the branchmetric calculated by the branchmetric calculation section and a path memory having a plurality of memory stages, each consisting of a plurality of memory elements, configured to obtain a decoded signal by shifting the information to be stored in the memory to a memory of a subsequent stage according to the outcome of selection of the pathmetric selection section, and defect detection section configured to detect a defect of the optical disc according to the information possessed by the memory of the last stage or of a specific stage of the path memory.

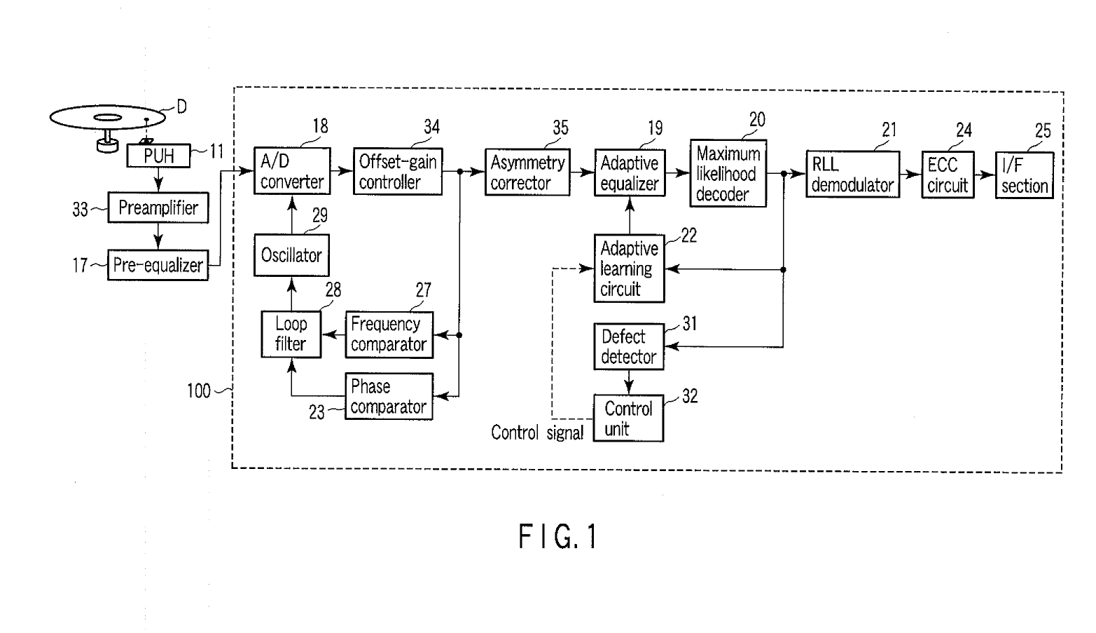

FIG. 1 is a schematic block diagram of a reproduction circuit of an embodiment of optical disc apparatus according to the present invention. Referring to FIG. 1, the optical disc apparatus according to the present invention includes an optical pickup head (PUH) 11 for irradiating a laser beam onto an optical disc D, receiving reflected light and outputting a read signal, a preamplifier 33 for amplifying the read signal, a pre-equalizer 17 for executing a filtering process on the amplified read signal, an A/D converter 18 for A/D converting the signal, an offset-gain controller 34 for controlling the offset-gain of the converted input signal, an asymmetry corrector 35 for correcting asymmetry, an adaptive equalizer 19 for executing a waveform equalizing process on the corrected signal, a maximum likelihood decoder 20 for executing a maximum likelihood decoding process on the waveform-equalized data, an RLL demodulator 21 for demodulating the decoded signal, an ECC circuit 24 for executing an error correction process on the demoded signal, an interface 25, an adaptive learning circuit 22 for optimizing the tap coefficient (equalization coefficient) of the adaptive equalizer according to the viterbi-decoded signal, a frequency comparator 27, a phase comparator 23, a loop filter 28, an oscillator 29, a defect detector 31 for detecting the defect of the optical disc according to the generated signal of the maximum likelihood decoder 20 and a control unit 32 for controlling the offset-gain controller 34, the asymmetry corrector 35, the adaptive learning circuit 22 and so on according to the output of the defect detector 31.

The interface 25, the ECC circuit 24, the A/D converter 18, the offset-gain controller 34, the asymmetry corrector 35, the adaptive equalizer 19, the maximum likelihood decoder 20, the RLL demodulator 21, the adaptive learning circuit 22, the phase comparator 23, the frequency comparator 27, the loop filter 28, the oscillator 29, the defect detector 31 and the control unit 32 are integrally formed in a single semiconductor chip (optical disc apparatus controller) 100.

Now, the operation of the recording/reproduction circuit in a replay process will be described below along with the overall operation of the circuit. The optical pickup 11 irradiates a laser beam of an appropriate intensity onto the optical disc D. As a result of the irradiation of the laser beam, the optical disc D reflects light with an intensity that corresponds to the data recorded on the optical disc D. The optical pickup 11 detects the reflected light and outputs an electric signal that corresponds to the quantity of reflected light. The electric signal is amplified by the preamplifier 33 and subjected to appropriate band limitation and, if necessary, waveform shaping. The output signal of the pre-equalizer 17 is converted into a digital signal by the A/D converter 18. The output signal of the A/D converter 18 proceeds by way of the offset-gain controller 34 and the asymmetry corrector 35 and is subjected to waveform equalization to show a response waveform (partial response waveform signal) that corresponds to the target partial response class by the adaptive equalizer 19. The equalization characteristic of the signal at this stage is adjusted by the adaptive learning circuit 22. The output of the adaptive equalizer 19 is subjected to determination of “1” or “0” of data by the maximum likelihood decoder 20 and turned into binary data. The obtained binary data is subjected to a process (demodulation) that is the inverse to RLL modulation by the RLL demodulator 21 to obtain recorded data. Simultaneously with the above operation, the frequency comparator 27 and the phase comparator 23 generate a clock signal according to the output of the offset-gain controller 34, controlling the oscillator 29 through the loop filter 28 to control the timings of various circuits in the inside of the semiconductor chip 100 including the A/D converter 18.

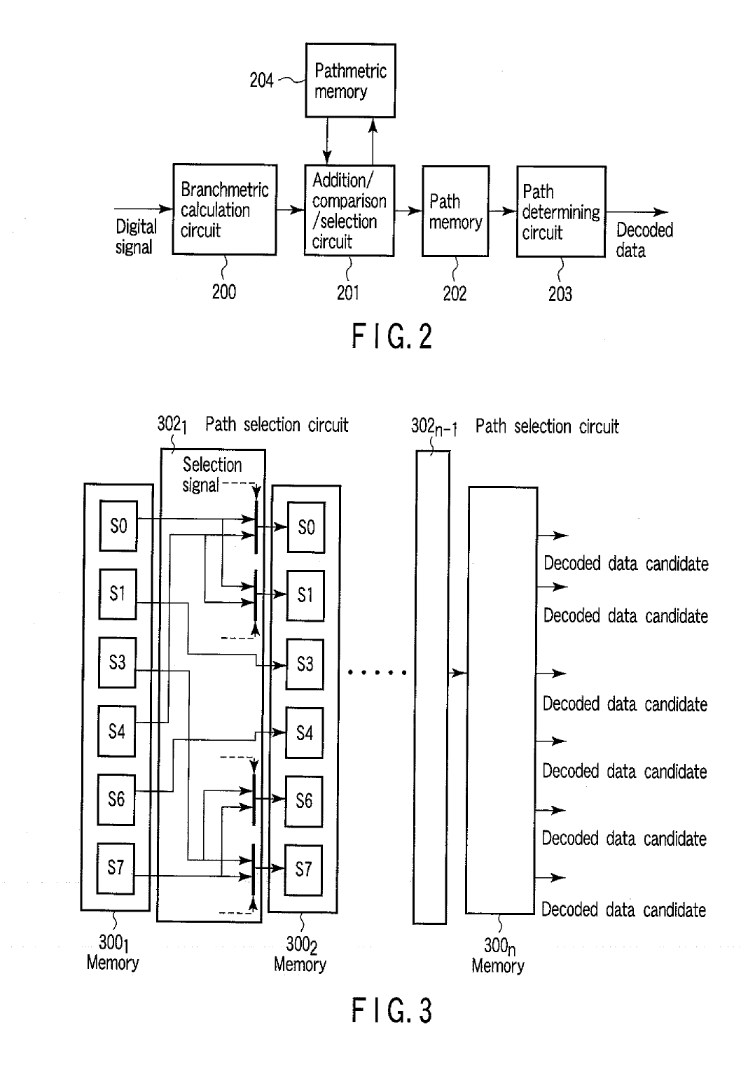

FIG. 2 is a schematic block diagram of the maximum likelihood decoder. The circuit illustrated in FIG. 2 shows the configuration of an ordinary viterbi decoding circuit. Referring to FIG. 2, a branchmetric calculation circuit 200 performs branchmetric calculations, using the input from the adaptive equalizer 19. An addition/comparison/selection circuit 201 executes an addition/comparison/selection process with a pathmetric value. A pathmetric memory 204 stores the selected pathmetric value. A path memory 202 stores the progress of path selection. A path determining circuit 203 takes out the output signal from the last stage memory and outputs the maximum likelihood result to the RLL demodulator 21. As a result, the most likely reproduced signal is finalized.

FIG. 3 is a schematic circuit diagram of the path memory 202, showing the configuration thereof. The path memory 202 is formed by memories 300ᵢ (i=1 to n) including memory elements S0, S1, S3, S4, S6 and S7 and path selection circuits 302ᵢ (i=1 to n), which are connected in a multiple of stages. The number of memory elements of the memories 300ᵢ (i=1 to n) is determined by the number of states of PR class assumed for maximum likelihood decoding. The selection signal from the addition/comparison/selection circuit 201 is input and the path selection circuit 302ᵢ (i=1 to n) is switched accordingly and an appropriate surviving path is stored in each of the memories 300ᵢ (i=1 to n) of the path memory 202.

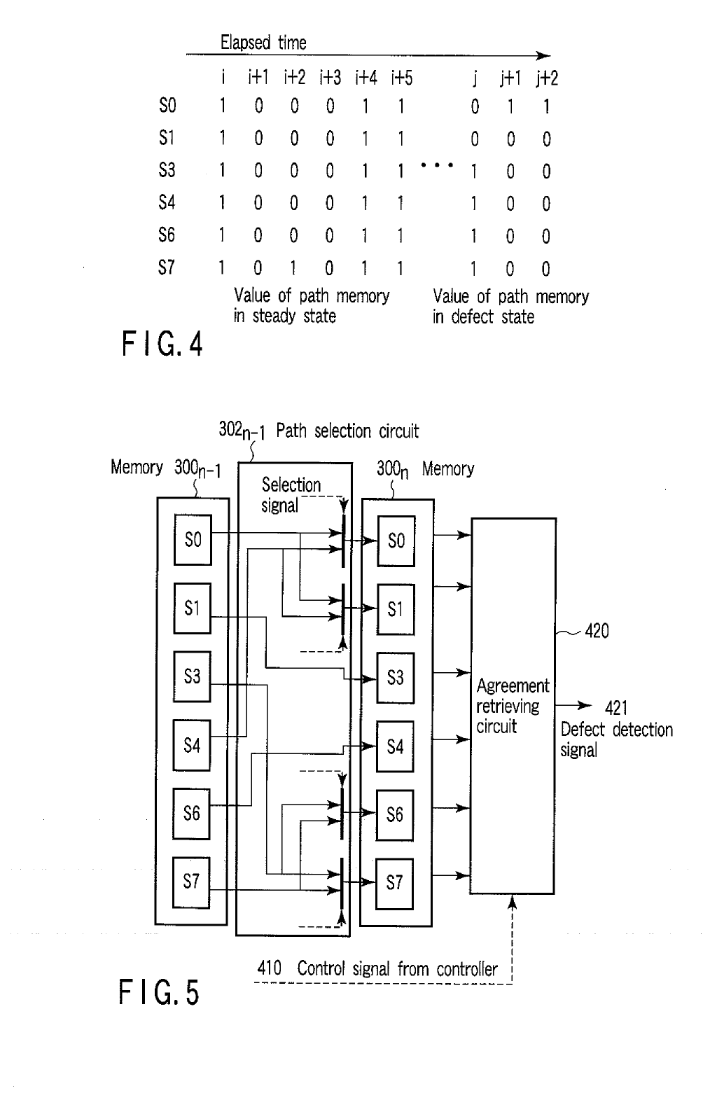

As the operation of pulling in the frequency and the phase completes and the coefficient learning of the adaptive learning circuit 22 is stabilized, the system restores the steady state and the maximum likelihood decoder outputs normal decoded data. FIG. 4 schematically illustrates the contents stored in the last stage memory 300ₙ of the path memory 202. In FIG. 4, the vertical axis corresponds to the stored contents that correspond to the states of PR class. Since there are six states when the minimum run length of sign is not less than two and the PR class (a, b, c, d) is PR (1, 2, 2, 1) or PR (3, 4, 4, 3), the memory elements are arranged in six stages in the longitudinal direction as shown in FIG. 4. In FIG. 4, the horizontal axis indicates the elapsed time. In FIG. 4, i to i+5 show the contents of the memory elements when the system is stabilized and normal decoded data is output. As shown in FIG. 4, the contents of the six memory elements S0, S1, S3, S4, S6 and S7 are coordinated by 1 or 0.

When a defect takes place on the optical disc, the contents of the six memory elements of the last stage memory 300ₙ of the path memory 202 are not coordinated as indicated by j to j+2 in FIG. 4. Thus, a defect whose envelop does not change remarkably, which has been heretofore difficult to detect, can be detected by utilizing this characteristic phenomenon.

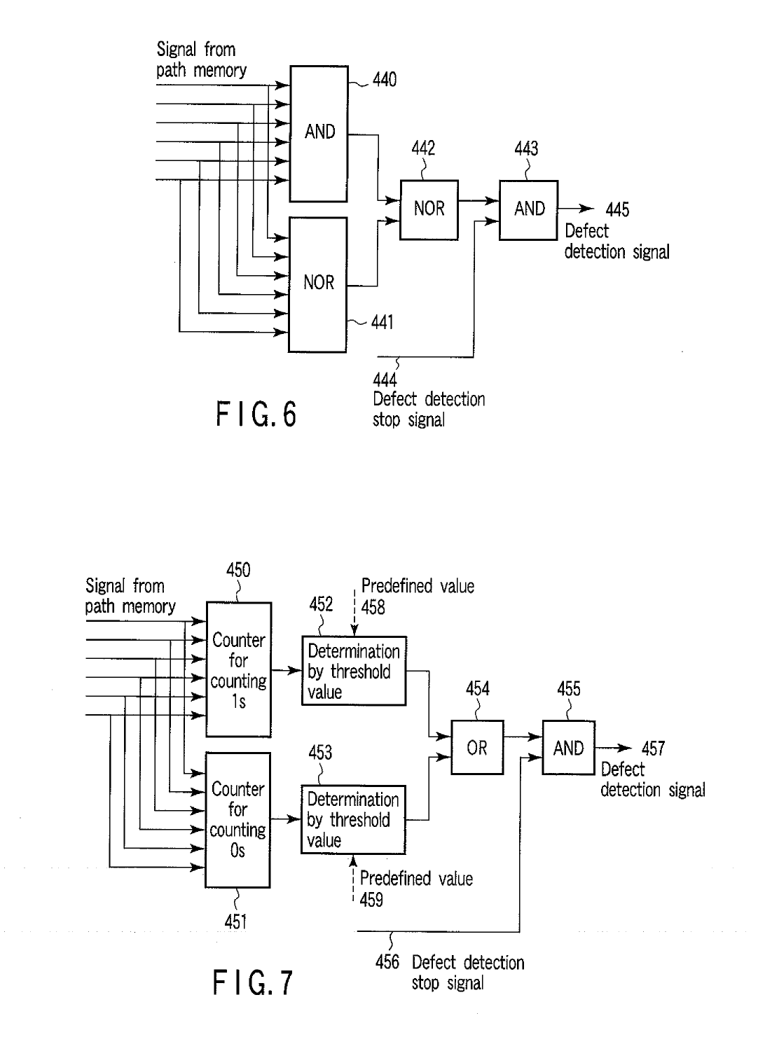

FIG. 5 is a schematic circuit diagram of an exemplar defect detector 31. A defect detection circuit 420 is connected to the memory 300ₙ of the last stage of the path memory or a memory 300ᵢ arranged after a number of stages sufficient for finalizing a path. FIG. 6 is a schematic illustration showing an example of inside of the defect detection circuit 420. The signal coming in from the path memory is received by an AND circuit 440 and a NOR circuit 441. When the contents of the path memory are coordinated by 1 or 0, the output of a NOR circuit 442 is 0 to prove that there is not any defect. When, on the other hand, the contents of the path memory are not coordinated by 1 or 0, the output of the NOR circuit 442 is 1 to prove that there is a defect. While the output of the NOR circuit 442 may be used as defect detection signal, a signal 445 obtained as the logical product of it and a defect detection stop signal 444 for stopping the defect detection and outputted from operated by an AND circuit 443 as shown in FIG. 6 may alternatively be used. For example, when it is not wanted to detect a defect because the frequency and/or the phase are not stabilized and/or the coefficient learning process is on the way, the defect detecting operation can be stopped by using the defect detection stop signal 444.

FIG. 7 is a schematic illustration showing another example of inside of the defect detector. The number of is and that of 0s input from the path memory are counted by means of counters 450, 451 respectively. The results of the counting operation and preset values 458, 459 are compared by means of threshold determining circuits 452, 453 and when either of the counted results is not greater or smaller than the corresponding preset value, a defect detection signal is output from an OR circuit 454. As in the case of the above-described example, an arrangement 455 for stopping the defect detection may be provided.

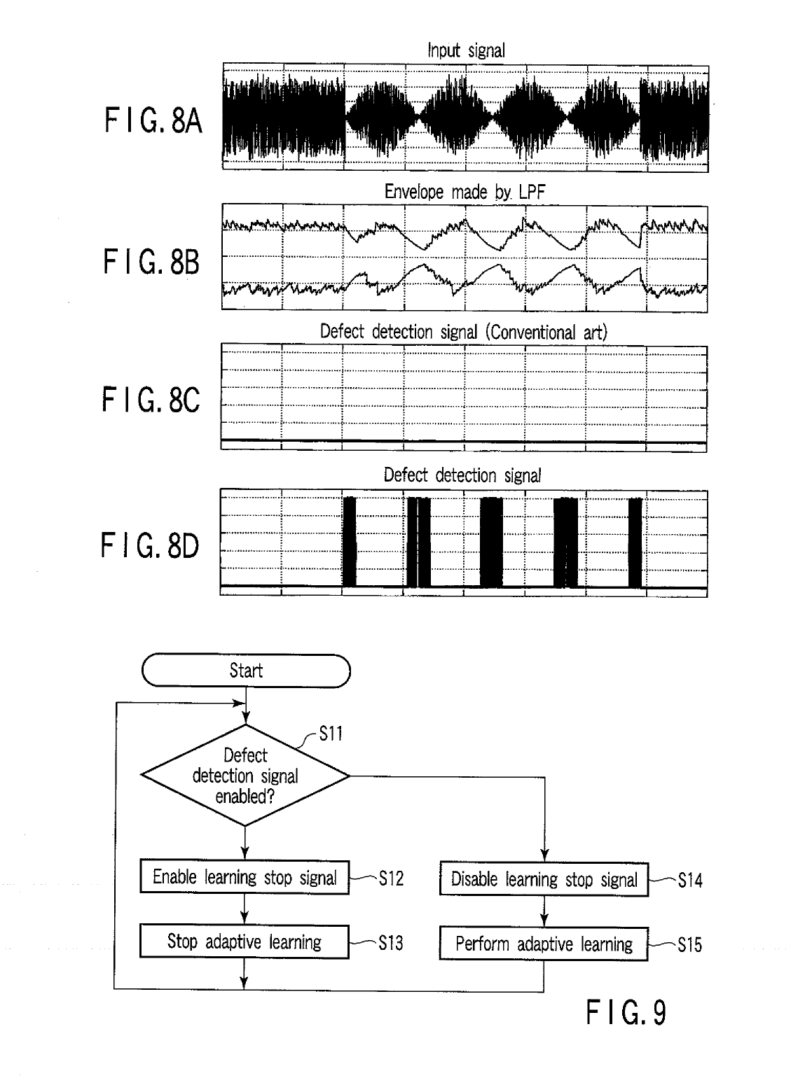

FIGS. 8A through 8D schematically illustrate an example of detection. FIG. 8A shows an RF signal output from the optical pickup 11 and FIG. 8B shows the envelop waveform of the waveform of FIG. 8A obtained by a low pass filter, while FIG. 8C is a defect detection signal output by the method disclosed in Jpn. Pat. Appln. Laid-Open Publication No. 2005-166121 and FIG. 8D is a defect detection signal output by the method of this embodiment of the present invention.

As seen from FIG. 8C, the conventional method cannot detect a defect of an optical disc. However, as shown in FIG. 8D, the method of this embodiment can detect the same defect.

Now, the process that the control unit 32 executes to control the adaptive learning circuit 22 according to the detection signal of the defect detector 31 will be described below by referring to the flowchart of FIG. 9.

The control unit 32 determines if the defect detection signal output from the defect detector 31 is enabling or not (Step S11). If it is determined that the defect detection signal is enabling (Step S13, Yes), the control unit 32 enables the learning stop signal it outputs to the adaptive learning circuit 22 (Step S12). As the learning stop signal is enabled, the adaptive learning circuit 22 stops the process of optimizing the tap coefficient (adaptive learning) (Step S13) and keeps on outputting the last coefficient obtained during the adaptive learning. If, on the other hand, it is determined that the defect detection signal is disabling (Step S11, No), the control unit 32 disables the learning stop signal (Step S14). The adaptive learning circuit 22 continues the adaptive learning (Step S15) and optimizes the tap coefficient.

As this embodiment detects defects of the type that the conventional art cannot detect, it is now possible to prevent any wrong learning of adaptive equalizer coefficients due to a defect of this type. Then, as a result, it is possible to raise the defect resistance of the optical disc apparatus. Additionally, as a result of prevention of wrong learning, it is possible to recover from a defect quickly.

When a defect is detected from an optical disc, the above-described embodiment has the adaptive learning circuit 22 stop the adaptive learning process. However, it may alternatively be so arranged that, when a defect is detected from an optical disc, the control unit 32 transmits a control signal to the asymmetry corrector 35 so as to have the asymmetry corrector 35 correct the asymmetry according to the quantity of adjustment immediately before the detection of the defect of the optical disc. Similarly, it may be so arranged that, when a defect is detected from an optical disc, the control unit 32 transmits a control signal to the loop filter 28 so as to have the loop filter 28 output the signal (quantity of adjustment) it outputted to the oscillator 29 immediately before the detection of the defect of the optical disc to the oscillator 29.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a read module configured to read reflected light from an optical disc and to output a read signal corresponding to the reflected light;
a decoder comprising a branchmetric calculation module configured to calculate a branchmetric for a signal generated by executing a predetermined process on the read signal, a pathmetric selection module configured to select a maximum likelihood pathmetric according to the calculated branchmetric, and a path memory having a plurality of memory stages each consisting of a plurality of memory elements, the path memory being configured to obtain a decoded signal by shifting information to be stored in the memory to a subsequent memory stage according to the outcome of selection of the pathmetric selection module; and
a defect detection module configured to detect a defect of the optical disc according to the information possessed by the last memory stage or by a specific stage of the path memory.

2. The apparatus of claim 1, wherein
the defect detection module is configured to detect a defect of the optical disc when all the data stored in all the memory elements in the memory of the last stage, or of the specific stage of the path memory, do not agree with each other.

3. The apparatus of claim 1, wherein the defect detection module is configured to count the number of data stored in all the memory elements in the memory of the last stage, or of the specific stage of the path memory, and to detect a defect of the optical disc when the counted value is smaller than a predefined value.

4. The apparatus of claim 1, further comprising:
an equalization circuit configured to execute an equalization process on the read signal according to an equalization coefficient and to output the signal generated by executing the predetermined process on the decoding circuit;
an equalization coefficient generating module configured to execute a process of optimizing the equalization coefficient according to the decoded signal and to output the optimized equalization coefficient to the equalization circuit; and
a control module configured to stop the operation of optimizing the equalization coefficient of the equalization coefficient generating section when the defect detection module detects a defect of the optical disc.

5. The apparatus of claim 4, wherein the control module is configured not to stop the operation of optimizing the equalization coefficient of the equalization coefficient generating circuit if the defect detection module detects a defect of the optical disc in the initial stage of optimizing the equalization coefficient.

6. The apparatus of claim 1, further comprising:
a processing module configured to computationally determine the quantity of adjustment from the read signal and to output a processed signal by executing a predetermined process on the read signal according to the quantity of adjustment; and
a control module configured to perform a predetermined process according to the quantity of adjustment computationally determined to the read signal when the processing module does not detect the defect if the defect detection section detects a defect of the optical disc.

7. The apparatus of claim 6, wherein the processing module comprises an asymmetry adjusting module configured to adjust the asymmetry of the read signal.

8. The apparatus of claim 6, wherein the processing module comprises a loop filter configured to supply a signal corresponding to the phase difference signal and the frequency error signal of the read signal to an oscillator and to generate a clock signal.

9. An optical disc apparatus controller comprising:
a decoder comprising a branchmetric calculation module configured to calculate a branchmetric for a signal generated by executing a predetermined process on a read signal corresponding to reflected light from an optical disc, a pathmetric selection module configured to select a maximum likelihood pathmetric according to the calculated branchmetric, and a path memory having a plurality of memory stages each consisting of a plurality of memory elements, the path memory configured to obtain a decoded signal by shifting the information to be stored in the memory to a subsequent memory stage according to the outcome of the selection of the pathmetric selection module; and
a defect detection module configured to detect a defect of the optical disc according to the information possessed by the last memory stage or by a specific stage of the path memory.

10. A defect detection method comprising:
detecting light reflected from an optical disc and outputting a read signal corresponding to the reflected light;
calculating a branchmetric for the signal generated by executing a predetermined process on the read signal;
selecting a maximum likelihood pathmetric according to the calculated branchmetric;
generating a decoded signal by shifting the information to be stored in a path memory having a plurality of memory stages each comprising a plurality of memory elements to a subsequent memory stage according to the outcome of the selection of the maximum likelihood pathmetric; and
detecting a defect of the optical disc according to the information possessed by the last memory stage or by a specific stage.

11. The method of claim 10, wherein a defect of the optical disc is detected when all the data stored in all the memory elements in the memory of the last stage or of the specific stage do not agree with each other.

12. The method of claim 10, wherein the number of data stored in all the memory elements in the memory of the last stage or of the specific stage is counted and a defect of the optical disc is detected when the counted value is smaller than a predefined value.

13. The method of claim 10, wherein the signal generated by executing the predetermined process comprises a signal obtained by executing an equalization process on the read signal according to an equalization coefficient, the method further comprising:
generating a new equalization coefficient by optimizing the equalization coefficient according to the decoded signal; and
stopping the execution of a process of optimizing the equalization coefficient when a defect of the optical disc is detected.

14. The method of claim 13, wherein the process of optimizing the equalization coefficient is not stopped when a defect of the optical disc is detected in the initial stage of optimizing the equalization coefficient.

15. The method of claim 13, further comprising:
computationally determining the quantity of adjustment from the read signal;
outputting a processed signal by executing a predetermined process on the read signal according to the quantity of adjustment; and
subjecting the read signal to the predetermined process according to the quantity of adjustment when a defect is not detected if the defect of the optical disc is detected.
